(19) United States
(12) Patent Application Publication
(10) Pub. No.: US 2012/0225235 A1
(43) Pub. Date: Sep. 6, 2012

(54) Non-slip buffer device

(76) Inventor: Dawn Marie Dorsch, Cottage Grove, MN (US)

(21) Appl. No.: 13/385,546

(22) Filed: Feb. 24, 2012

Related U.S. Application Data
(60) Provisional application No. 61/448,254, filed on Mar. 2, 2011.

(51) Int. Cl. C09J 7/02; B32B 33/00; B32B 7/12

(52) U.S. Cl. 428/41.7; 428/343; 428/354

(57) ABSTRACT

A non-slip or anti-slip buffer device which is to be affixed to the underside of shoulder straps of purses, bags, bras, shoulder straps on clothing, backpacks, luggage, cameras, guns, etc. . . . to help prevent the strap or straps from sliding off of the shoulder of the user while remaining concealed from view. The non-slip buffer device is a self-adhesive, flexible, semi-permanent, device made of a slip resistant material. Position the self-adhesive side to the underside of the strap at the shoulder area, the pressure created from the normal tension of the shoulder strap against the wearer's shoulder along with the slip resistant material or coating prevent or minimize slippage of the strap on the user's shoulder.

### CROSS-REFERENCE TO RELATED APPLICATIONS

This application claims priority to U.S. Provisional Patent Application Ser. No. 61/448,254, filed on Mar. 2, 2011 and entitled “Non-Slip Invisigrip”, the content of which being incorporated herein in its entirety.

### BACKGROUND OF THE INVENTION

1. Field of the Invention

The present invention relates to a non-slip buffer device, to be used in conjunction with purses, bags, bras, shoulder straps on clothing, luggage etc. . . . having shoulder straps, to prevent or minimize slippage of said straps from the shoulder while being concealed.

2. Background of Prior Art

Shoulder straps are used to carry a wide variety of items such as purses, bags, backpacks, luggage, cameras, guns, etc. Shoulder straps also are used on bras and on clothing i.e. spaghetti straps, lingerie tank tops and camisoles etc. . . . A major problem of such straps is the fact that they tend to slip off of the shoulder. Often time's users of such straps find themselves raising the shoulder carrying the load to help keep the strap from slipping off the shoulder causing them to tilt as they walk. With regard to prior art several attempts have been made to alleviate said problems. While some of these devices do prevent minor slippage, most of these devices are cumbersome, bulky and difficult to attach and remove and all are clearly visible. The present device is neatly concealed as it is attached to the underside of the strap so as to not take away from the visual design of the strap while preventing slippage.

This invention addresses the problem of straps slipping off of the user's shoulder; helps reduce the need to tilt the user's shoulders to maintain the strap on the shoulders while being concealed from view.

### SUMMARY OF THE INVENTION

The purpose of this invention is to provide a non-slip, non-visible, buffer device for shoulder straps of carrying bags and clothing, such as but not limited to, purses, bags, bras, shoulder straps on clothing, backpacks and luggage etc. . . . This will prevent or minimize slippage of these straps. Designed to affix to the underside of straps worn on a user's shoulder, providing effective non-slip gripping action to help prevent slippage off of the shoulder under most conditions and is virtually unnoticeable.

It is yet another object of the present invention to provide a non-slip buffer device that is comprised of a self-adhesive type of fastener adhered to or coated with, a non-slip material.

The buffer device is a two piece unit, comprised of a flat strip having its upper surface a self-adhesive with peel-off backing, thereof; adhered to, or coated with, a non-slip material of the same dimensions, which resist slipping on the shoulder.

Another object of this invention is to provide a non-slip buffer device for shoulder straps in luggage such as but not limited to, briefcases, carry-on bags, computer cases, handbags, cameras and guns etc. . . . that will prevent or minimize slippage of these straps.

It is another object of the present invention to provide a non-slip buffer device that is concealed from view when applied in the intended fashion.

When used, the retainer is placed underneath the shoulder strap of the purse, bag or clothing, in line with the shape of the existing shoulder strap, and in the general shoulder area. The self-adhesive side is placed on the underside of the shoulder strap, while the non-slip material or coating is placed on the wearer's shoulder; the buffer unit conforms to and grips onto user's person or user's clothing.

The non-slip buffer device is designed to be of a width no greater than the shoulder strap on which it is to be used, thus providing a non-obstructive, non-distracting, discreet solution.

The buffer device is held in place by the adhesive component on the upper surface of the unit which is affixed to the underside of the shoulder strap, the non-slip material placed against the wearer's shoulder, and the pressure created from the normal tension of the shoulder strap against the wearer's shoulder.

The non-slip buffer device is washable and re useable. Remove the buffer device, rinse with water, air dry and reapply.

The device is of relatively simple design and construction and is easy to use.

### BRIEF DESCRIPTION OF THE DRAWINGS

FIG. 1 is a side view of a device of the present invention; and

FIG. 2 is a schematic illustration of the device of FIG. 1 in use.

### DETAILED DESCRIPTION OF THE DRAWINGS

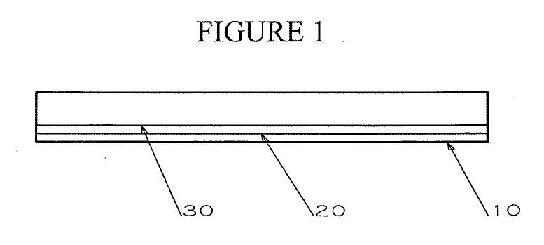

Referring to the drawings, and in particular, FIG. 1, there is provided a side view of the present invention having a peel-off strip generally represented by reference numeral 10, self-adhesive portion, generally represented by reference numeral 20, and a non-slip material portion 30.

Portion 20 is the surface that will be positioned on the underside of the shoulder strap, using a device no wider that the strap itself. The opposite surface 30 will be placed with the non-slip material or coating against the wearer's shoulder.

In a preferred embodiment, portions 20 and 30 are fabricated with the same dimensions and joined together by an adhesive compound applied to their backing along with the peel off backing.

In an alternative embodiment, portion 20 and 30 may be joined together by means of foam lamination.

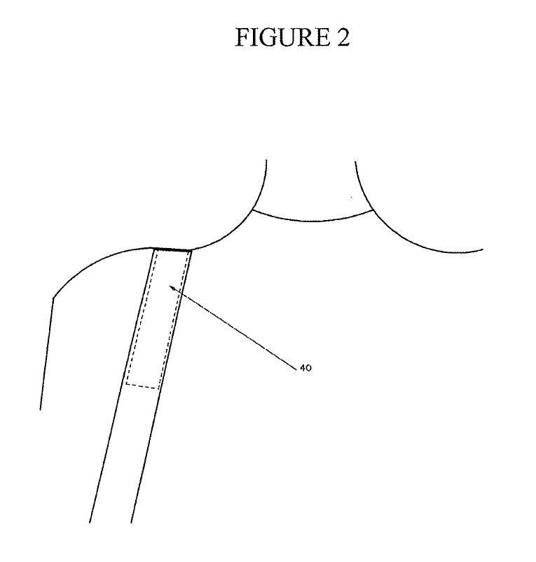

In yet another embodiment, FIG. 2 the self-adhesive surface 20 may be directly coated, laminated, or embossed with a non-slip material on the underside of the self-adhesive material.

Portions 20 and 30 are joined together to form a single unit, with all edges the same.

The invention, FIG. 1 is a stand-alone device which does not need to be permanently attached to the shoulder strap to perform its intended function. It can be removed easily from the strap. It can also be rinsed with water, air dried and re applied to the same or another strap.

In the preferred embodiments, the buffer device is easily concealed beneath an existing shoulder strap of a bag article 40.

The present invention set forth may be changed, modified, or altered therein without departing from the scope or spirit of the appended claims.

I claim:

1. A buffer device existing as a stand-alone device comprised of a first surface bearing adhesive thereof, and a second surface having a non-slip material or coating, with both surfaces having the same dimensions.

2. The buffer device of claim 1, wherein the surfaces of the adhesive and the non-slip material are combined to form a single unit.

3. The buffer device of claim 1, wherein the said first surface having an adhesive thereof is adhered to a second surface having non-slip properties by means of adhesive compounds or lamination.

4. The buffer device of claim 1, wherein the device is of a width no greater than the shoulder strap on which it is applied.

5. The buffer device of claim 1, in which the buffer unit device is attached to the shoulder strap by means of placing the adhesive side of the device on the underside of the existing shoulder strap, with the non-slip surface positioned against the shoulder portion of the wearer.

6. The buffer device of claim 1, whereby said buffer unit device is placed directly underneath the existing shoulder strap, and positioned to be totally concealed.

7. The buffer device of claim 1, wherein the device can be removed, rinsed with water, air dried and re applied to the same or another strap.

8. An elongate non-slip, semi-permanent, flexible, self-adhesive, non-visible buffer device for the application to the underside of shoulder straps where the strap itself lands on the body to decrease slippage with respect to your clothing and or your person; wherein the buffer device, having a shape, size and contour conforming to the shape, size and contour of the area of contact between the strap itself and the person's body, is made from a material having three, flexible, self-conforming layers, namely, an outer friction layer made from a slip-resistant material, and intermediate adhesive layer for semi-permanent adhesion of the friction layer to the strap, and a peel-off backing layer to protect the adhesive layer until the buffer is applied to the strap.
